(19) United States
(12) Patent Application Publication
(10) Pub. No.: US 2026/0175462 A1
(43) Pub. Date: Jun. 25, 2026

(54) SYSTEM AND METHOD FOR DETERMINING CUT QUALITY

(71) Applicant: Honeywell Federal Manufacturing & Technologies, LLC, Kansas City, MO (US)

(72) Inventors: Andrew David Deal, Overland Park, KS (US); Steve LaPlant, Kansas City, MO (US); Daniel Kessler, Stilwell, KS (US); Peter Fehner, Kansas City, MO (US)

(21) Appl. No.: 18/989,163

(22) Filed: Dec. 20, 2024

(51) Int. Cl. B26D 7/27; B23K 26/03

(52) U.S. Cl. CPC B26D 7/27; B23K 26/032

(57) ABSTRACT

A system for determining a quality of a cut made in a target sample comprises a substrate, a sensor, and a computing device. The substrate includes a groove formed in an upper surface thereof. The substrate is configured to have the target sample positioned on the upper surface over at least a portion of the groove such that the cut is made in the target sample by a cutting device. The sensor is configured to detect and capture data from the groove and output the data. The computing device is configured to receive the data from the sensor, determine a portion of the groove that is detected according to the data from the sensor, and determine a pass or a fail of the cut according to the portion of the groove that is detected.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### FIELD OF THE INVENTION

Embodiments of the current invention relate to a precision measurement system and method for determining a quality of a cut in a target sample.

### BACKGROUND OF THE INVENTION

Cutting devices, such as machining saws, laser beam or e-beam systems, and the like, may shift out of tolerance over time. That is, the devices may no longer cut on a desired or targeted line. The cut that the devices make may be off center from the desired line, may be too broad or too narrow. It is desirable to be able to detect when a cutting device is no longer performing properly.

The background discussion is intended to provide information related to the present invention which is not necessarily prior art.

### SUMMARY OF THE INVENTION

Embodiments of the current invention address one or more of the above-mentioned problems and provide a system and a method for determining a quality of a cut in a target sample, wherein alignment of the cut with a groove in an underlying substrate determines the quality of the cut. An embodiment of the system broadly comprises a substrate, a sensor, and a computing device. The substrate includes a groove formed in an upper surface thereof. The substrate has the target sample positioned on the upper surface over at least a portion of the groove such that the cut is made in the target sample by a cutting device. The sensor is configured to detect and capture data from the groove and output the data. The computing device receives the data from the sensor, determines a portion of the groove that is detected according to the data from the sensor, and determines a pass or a fail of the cut according to the portion of the groove that is detected.

Another embodiment of the system broadly comprises a substrate, a sensor, and a computing device. The substrate includes a groove formed in an upper surface thereof. The substrate has the target sample positioned on the upper surface over at least a portion of the groove such that the cut is made in the target sample by a cutting device. The sensor is configured to detect and capture data from the groove and output the data. The computing device receives the data from the sensor, determines a portion of the groove that is detected according to the data from the sensor, determines a pass of the cut if a portion greater than 0% and less than 100% of the groove is detected, and determines a fail of the cut if none of the groove is detected, or if all of the groove is detected.

An embodiment of the method broadly comprises placing the target sample on an upper surface of a substrate including a groove such that the target sample covers at least a portion of the groove; cutting the target sample to form a cut along a path in rough alignment with the groove; visually inspecting the groove to determine a portion of the groove that is visible; and determining a pass or a fail of the cut according to the portion of the groove that is visible.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1A is an upper perspective isometric view of a substrate used in a precision measurement system, constructed in accordance with various embodiments of the current invention, for determining a quality of a cut in a target sample, the substrate including a groove formed in its upper surface;

FIG. 1B is an elevational view from a first end of the substrate;

FIG. 2A is an upper perspective isometric view of the substrate with a target sample positioned on its upper surface;

FIG. 2B is an elevational view from the first end of the substrate and the target sample;

FIG. 3A is an upper perspective isometric view of the substrate with the target sample and a cutting device prepared to cut the target sample;

FIG. 3B is an elevational view from the first end of the substrate and the target sample with the cutting device prepared to cut the target sample;

FIG. 4A is an upper perspective isometric view of the substrate with the target sample after it has been cut and a sensor inspecting the cut;

FIG. 4B is an elevational view from the first end of the substrate with the target sample after it has been cut and the sensor inspecting the cut;

FIG. 5A is an elevational view from the first end of the substrate with the target sample after it has been cut illustrating a first example of a cut that fails inspection;

FIG. 5B is an elevational view from the first end of the substrate with the target sample after it has been cut illustrating a second example of a cut that fails inspection; and

FIG. 6 is a listing of at least a portion of the steps of an exemplary method for determining a quality of a cut in a target sample.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

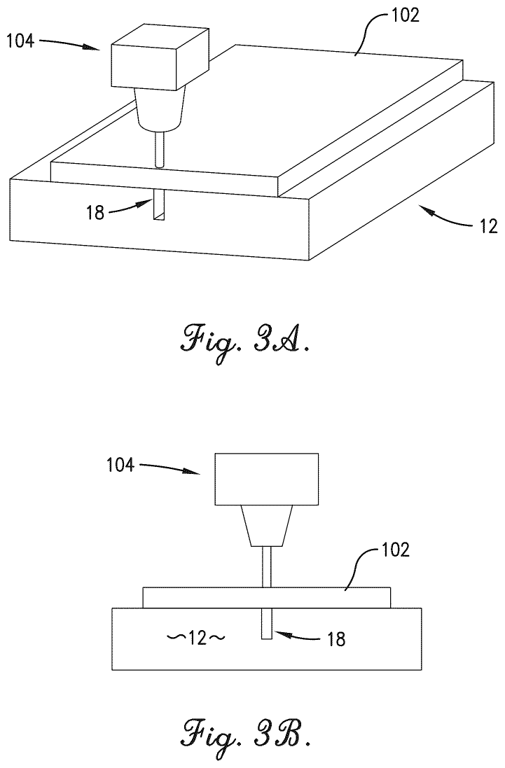

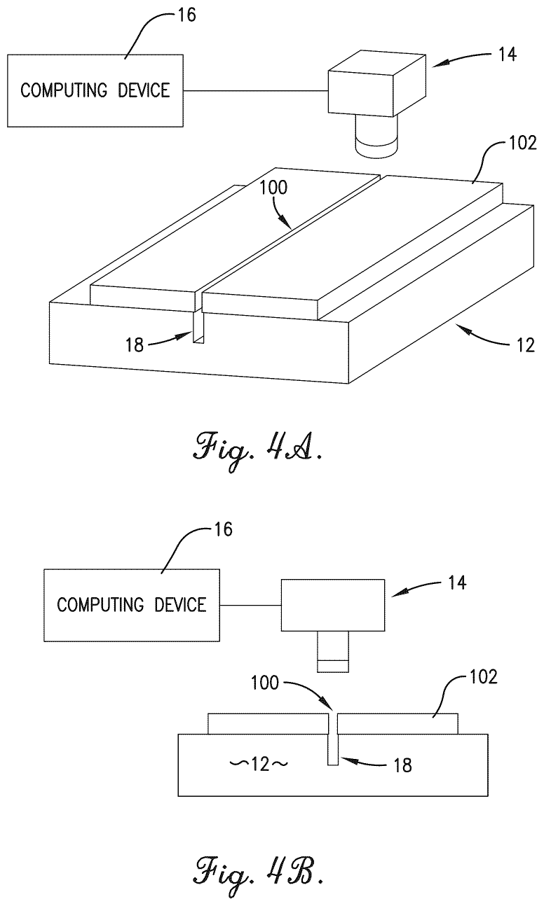

A system 10, constructed in accordance with various embodiments of the current invention, for determining a quality of a cut 100 in a target sample 102 is shown in FIGS. 4A and 4B. The system 10 broadly comprises a substrate 12, a sensor 14, and a computing device 16. The system 10 is utilized with a cutting device 104, shown in FIGS. 3A and 3B, to determine the quality of the cut 100 made in the target sample 102 and whether the cut 100 receives a pass or a fail based on the quality.

The target sample 102 may be formed from nearly any material, such as metals, plastics, wood, and the like, and may have nearly any shape that can be accommodated by the cutting device 104.

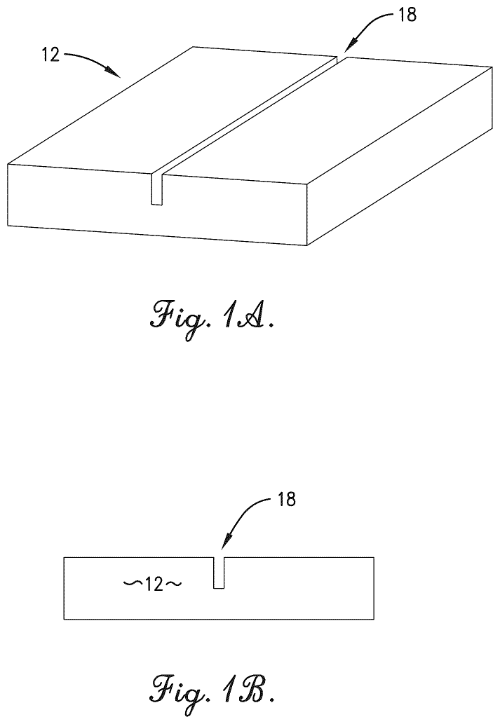

The substrate 12, shown in isolation in FIGS. 1A and 1B, may be a base, or at least a portion of a base, of a machining system, a laser or e-beam cutting system, the sensor 14, or the like—wherein the substrate 12 includes at least an upper surface. In other embodiments as shown in the figures, the substrate 12 may be a block having an upper surface, a lower surface, a left side surface, a right side surface, a front surface, and a rear surface. The substrate 12 includes a groove 18. In exemplary embodiments, the groove 18 is positioned in the upper surface and extends linearly from the front surface to the rear surface. In other embodiments, the groove 18 may have other shapes or footprints on the upper surface, such as one or more curvatures, one or more piecewise segments intersecting at angles between 0 degrees and 180 degrees, and so forth. In still other embodiments, the groove 18 may have a closed path, such as a circle, an oval, a triangle, or other geometric or polygonal shape. The groove 18 may have a profile that is bounded by a groove left side surface, a groove right side surface, and a groove lower surface. The groove side surfaces connect to the groove lower surface at approximately a 90-degree angle, and the groove side surfaces connect to the upper surface of the substrate 12 at approximately a 90-degree angle. The substrate 12 is formed from material that is less likely to be damaged by cutting of the target sample 102.

In other embodiments, the groove 18 could function as a relief mapping where it outlines a defined zone of material to be removed. In still other embodiments, the groove 18 may include just a visual indication of a groove without having any impression or indentation in the surface of the substrate 12. For example, the groove 18 may include paint, or other marking material such as ink, mark the surface along the path where a physical groove would be. The paint or ink may be high contrast, high visibility, fluorescent, or the like.

The sensor 14 generally detects and captures data regarding the cut 100 of the target sample 102. In some embodiments, the sensor 14 includes system-level components such as a three-dimensional positioning system guiding a video source such as a microscope having one or more lenses and an optical sensor or a camera having one or more lenses that provide a visual inspection of the cut 102 and the groove 18. The sensor 14 may output or communicate video data generated from the video source, wherein the video data includes digital, binary-form data derived from images captured by the lense(s). The images may include images of the target sample 102, the cut 100, the substrate 12, the groove 18, and so forth. The sensor 14 may include a monitor to display the images.

In some embodiments, the sensor 14 may include ultrasonic and/or radio frequency sensors, i.e., transmitters and receivers which transmit waves of radiation, at ultrasonic frequencies or higher, toward the cut 100 and receive reflections from the target sample 102, the cut 100, the substrate 12, and the groove 18. The receiver(s) may output data resulting from the reflections. The sensor 14 may use the receiver data to generate grayscale image video data which can be output or communicated to the computing device 16.

The computing device 16 may be embodied by, or may include, one or more servers, high performance computers, workstation computers, desktop computers, laptop computers, palmtop computers, notebook computers, tablets or tablet computers, and so forth. The computing device 16 also includes one or more processors to execute software applications, one or more memory components to store software applications and data, and one or more communication elements to communicate with other devices or systems. The computing device 16 is in electronic communication with the video source of the sensor 14 and configured to receive video data from the video source. The computing device 16 is further configured to determine whether the cut 100 passes or fails using either existing vision or image recognition algorithms or advanced ones employing artificial intelligence and machine learning.

The cutting device 104 may include machining or cutting apparatuses such as a saw with a blade, laser or e-beam cutting systems such as a femtosecond laser machine, and so forth. Exemplary embodiments of the cutting device 104 shown in FIGS. 3A and 3B include a laser emitting a laser beam. In various embodiments, the sensor 14 may be integrated with the cutting device 104 in a single machine.

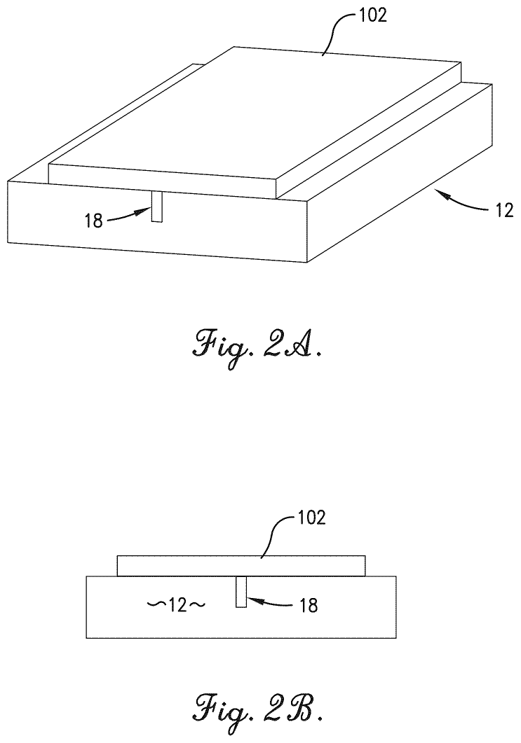

The system 10 may operate as follows with reference to FIGS. 2A, 2B, 3A, 3B, 4A, and 4B. The target sample 102 is placed on the upper surface of the substrate 12 over the groove 18. The cutting device 104 is positioned over the target sample 102 in general alignment with the groove 18. The cutting device 104 cuts the target sample 102 along a path that follows the groove 18, but does not cut into the groove 18. Any debris from cutting the target sample 102 is optionally removed. The sensor 14 is positioned above an upper surface of the target sample 102 in alignment with the groove. In some embodiments, a center of the lens of the sensor 14 is positioned above, and in vertical alignment with, a center of the cut 100. In other embodiments, the center of the lens may be offset with the center of the cut 100, as long as the lens can view into the cut 100. The lens of the sensor 14 may be positioned at a single point above the cut 100 to capture a single video image, at multiple points along the cut 100 to capture multiple video images, or may scan the length of the cut 100 to capture a stream of video images.

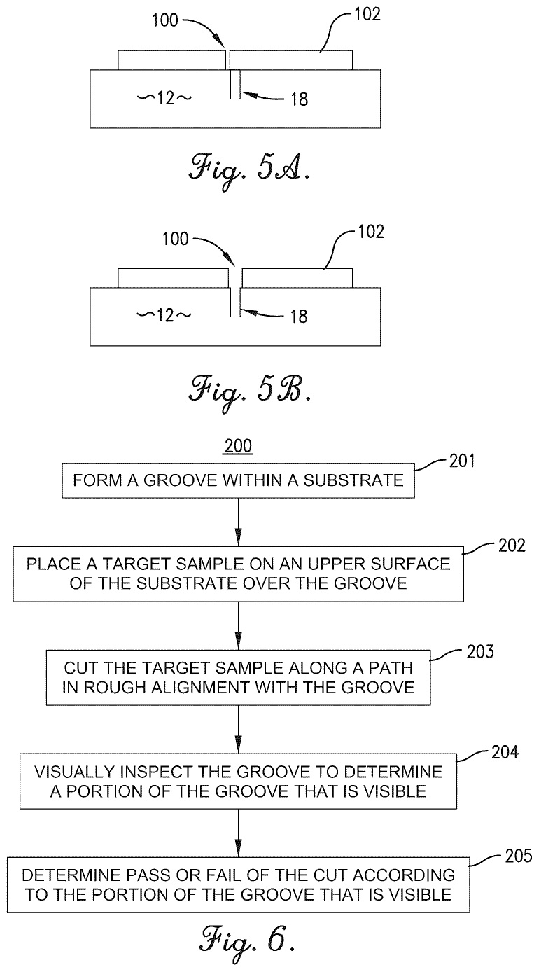

The video source of the sensor 14 transmits or communicates the video image(s) to the computing device 16 which employs image recognition algorithms, artificial intelligence, and/or machine learning to determine one of three possible conditions regarding visibility of the groove 18 beneath the cut 100. The conditions include (1) a portion (greater than 0% and less than 100%) of the groove 18 is visible, as shown in FIG. 4B, (2) none of the groove 18 is visible, as shown in FIG. 5A, or (3) all of the groove 18 and possibly some of the upper surface of the substrate 12 are visible, as shown in FIG. 5B. If the computing device 16 determines that condition (1) exists, then the computing device 16 determines that the cut 100 is within tolerance and the cut 100 is passed. If the computing device 16 determines that conditions (2) or (3) exist, then the computing device 16 determines that the cut 100 is out of tolerance and it fails.

In other embodiments, the groove 18 and the cut 100 may be visible on a monitor associated with the sensor 14, the computing device 16, or both. Additionally, or alternatively, the groove 18 and the cut 100 may be visible through a microscope, a magnifying glass, or even to the naked eye. Thus, a human technician may be able to determine which of the conditions listed above exist and accordingly determine whether the cut 100 is in tolerance and it passes or out of tolerance and it fails.

FIG. 6 depicts a listing of at least a portion of the steps of an exemplary method 200 for determining a quality of a cut 100 in a target sample 102. Variations to the steps may be performed. The steps may be performed in the order shown in FIG. 6, or they may be performed in a different order. Furthermore, some steps may be performed concurrently as opposed to sequentially. In addition, some steps may be optional or may not be performed. Some steps may be performed by a processor of the computing device 16 via hardware, software, firmware, or combinations thereof.

Referring to step 201, a groove 18 within a substrate 12 is formed. The substrate 12 may be a base, or at least a portion of a base, of a machining system, a laser or e-beam cutting system, a sensor 14, or the like—wherein the substrate 12 includes at least an upper surface. In other embodiments as shown in the figures, the substrate 12 may be a block having an upper surface, a lower surface, a left side surface, a right side surface, a front surface, and a rear surface. In exemplary embodiments, the groove 18 is positioned in the upper surface and extends linearly from the front surface to the rear surface. In other embodiments, the groove 18 may have other shapes or footprints on the upper surface, such as one or more curvatures, one or more piecewise segments intersecting at angles between 0 degrees and 180 degrees, and so forth. In still other embodiments, the groove 18 may have a closed path, such as a circle, an oval, a triangle, or other geometric or polygonal shape. The groove 18 may have a profile that is bounded by a groove left side surface, a groove right side surface, and a groove lower surface. The groove side surfaces connect to the groove lower surface at approximately a 90-degree angle, and the groove side surfaces connect to the upper surface of the substrate 12 at approximately a 90-degree angle. The substrate 12 is formed from material that is less likely to be damaged by cutting of the target sample 102.

In other embodiments, the groove 18 could function as a relief mapping where it outlines a defined zone of material to be removed. In still other embodiments, the groove 18 may include just a visual indication of a groove without having any impression or indentation in the surface of the substrate 12. For example, the groove 18 may include paint, or other marking material such as ink, mark the surface along the path where a physical groove would be. The paint or ink may be high contrast, high visibility, fluorescent, or the like.

Referring to step 202, a target sample 102 is placed on an upper surface of the substrate 12 over the groove 18. The target sample 102 may be formed from nearly any material, such as metals, plastics, wood, and the like.

Referring to step 203, the target sample 102 is cut (forming a cut 100) along a path in rough alignment with the groove 18. The target sample 102 is cut using a cutting device 104 which may include machining or cutting apparatuses such as a saw with a blade, laser or e-beam cutting systems such as a femtosecond laser machine, and so forth. Exemplary embodiments of the cutting device 104 shown in FIGS. 3A and 3B include a laser emitting a laser beam.

Referring to step 204, the groove 18 is visually inspected by a sensor 14 to determine a portion of the groove 18 that is visible beneath the cut 100. The sensor 14 may include a microscope with one or more lenses, a camera with one or more lenses, a three-dimensional positioning system, or the like or combinations thereof. The sensor 14 may further include a computing device 16 in electronic communication with the camera (or other video source) of the sensor 14 and configured to receive video data from the camera (or other video source).

Referring to step 205, determine pass or fail of the cut 100 according to the portion of the groove 18 that is visible. The video source of the sensor 14 transmits or communicates the video image(s) to the computing device 16 which employs image recognition algorithms, artificial intelligence, and/or machine learning to determine one of three possible conditions including (1) a portion (greater than 0% and less than 100%) of the groove 18 is visible, as shown in FIG. 4B, (2) none of the groove 18 is visible, as shown in FIG. 5A, or (3) all of the groove 18 and possibly some of the upper surface of the substrate 12 are visible, as shown in FIG. 5B. If the computing device 16 determines that condition (1) exists, then the computing device 16 determines that the cut 100 is within tolerance and the cut 100 is passed. If the computing device 16 determines that conditions (2) or (3) exist, then the computing device 16 determines that the cut 100 is out of tolerance and it fails.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for determining a quality of a cut made in a target sample, the system comprising:
a substrate including a groove formed in an upper surface thereof, the substrate configured to have the target sample positioned on the upper surface over at least a portion of the groove such that the cut is made in the target sample by a cutting device;
a sensor configured to detect and capture data from the groove and output the data; and
a computing device configured to:
receive the data from the sensor,
determine a portion of the groove that is detected according to the data from the sensor, and
determine a pass or a fail of the cut according to the portion of the groove that is detected.

2. The system of claim 1, wherein the groove extends linearly from one end surface of the substrate to an opposing end surface of the substrate.

3. The system of claim 1, wherein the computing device is further configured to:
determine a pass of the cut if a portion greater than 0% and less than 100% of the groove is detected, and
determine a fail of the cut if none of the groove is detected, or if all of the groove is detected.

4. A system for determining a quality of a cut made in a target sample, the system comprising:
a substrate including a groove formed in an upper surface thereof and extends non-linearly from one end surface to an opposing end surface, the substrate configured to have the target sample positioned on the upper surface over a portion of the groove such that the cut is made in the target sample by a cutting device;
a sensor configured to detect and capture data from the groove and output the data; and
a computing device configured to:
receive the data from the sensor,
determine a portion of the groove that is detected according to the data from the sensor,
determine a pass of the cut if a portion greater than 0% and less than 100% of the groove is detected, and
determine a fail of the cut if none of the groove is detected, or if all of the groove is detected.

5. The system of claim 4, wherein the groove forms a closed loop.

6. The system of claim 4, wherein the groove forms a continuous structure.

7. A method for determining a quality of a cut made in a target sample, the method comprising:
placing the target sample on an upper surface of a substrate including a groove such that the target sample covers at least a portion of the groove;
cutting the target sample to form a cut along a path in rough alignment with the groove;
visually inspecting the groove to determine a portion of the groove that is visible; and
determining a pass or a fail of the cut according to the portion of the groove that is visible.

8. The method of claim 5, further comprising:
determining a pass of the cut if a portion greater than 0% and less than 100% of the groove is visible, and
determining a fail of the cut if none of the groove is visible, or if all of the groove is visible.

9. The method of claim 5, further comprising forming the groove in the substrate before the target sample is cut.
